(19) United States
(12) Patent Application Publication
(10) Pub. No.: US 2026/0060220 A1
(43) Pub. Date: Mar. 5, 2026

(54) An aquaculture system and a method of farming aquatic organisms

(71) Applicant: PaRAS Aqua Oy, Laukaa (FI)

(72) Inventor: Tapio Kiuru, Laukaa (FI)

(21) Appl. No.: 19/105,838

(22) PCT Filed: Jul. 12, 2023
(86) PCT No.: PCT/FI2023/050439

§ 371 Date: Feb. 24, 2025

(30) Foreign Application Priority Data
Aug. 23, 2022 (FI) 20225741

(51) Int. Cl. A01K 63/04; A01K 61/10; A01K 61/59; A01K 61/60; A01K 63/10

(52) U.S. Cl. CPC A01K 63/042; A01K 61/10; A01K 61/59; A01K 61/60; A01K 63/045; A01K 63/10

(57) ABSTRACT

An aquaculture system, such as a fish or shrimp farming system, is provided and based on recirculation aquaculture, the system comprising: at least two farming tanks 105e; at least one tank-specific water treatment unit (106d, 107h) that is connected to one of the tanks and configured to treat water of said tank; at least one shared water treatment unit (108, 109) that is connected to all of the tanks and configured to treat water that is recirculating in the system; and a means 101a for recirculating water in the system.

### FIELD

The present application relates to an aquaculture system, and particularly to a fish farming system utilizing both tank-specific water treatment units and shared water treatment units.

### BACKGROUND

Aquaculture, generally referred to as farming of aquatic organisms, such as fish and shellfish, under controlled conditions, is a fast-growing agricultural sector that allows for harvesting seafood for human and animal consumption. By means of aquaculture a variety of aquatic species can be produced in a cost-effective manner and with predictable yields regardless of external conditions, such as weather and/or population fluctuations.

In recent decades, fish harvesting in aquaculture facilities with complete or partial water recirculation has gained popularity and profitability over traditional rearing of fish in open ponds. Recirculation aquaculture systems (RAS) vary in design, according to production goals and geographical locations. Common practices include using raceway systems configured as rectangular tanks with baffles or a series of tanks, or using rearing facilities comprising a series of round-shaped ponds or tanks, in where circular water current is established around a central drain.

Aquaculture has been the fastest growing animal production sector in the world for several decades. Especially land-based production of salmonids is now growing extremely fast, as traditional production areas and methods cannot meet fast-growing demand. According to conservative estimations, the growth rate of land-based sector will be about 60% per year over the next 10 years. Despite of the high and growing interest on Recirculation Aquaculture System (RAS) technology, biological problems and risks in the RAS concept have not been completely solved, and the grow-out RAS-farms have not yet proven their profitability.

In conventional recirculation aquaculture farms there is/are a shared unit or units for carrying out the necessary water treatment steps in a centralized manner for the entire farm. The unit typically comprises several functions or sub-units dedicated for example for aerating and purifying the water. A disadvantage is that the system does not provide much flexibility with regard how the individual fish tanks can be operated.

Alternatively, it is known to provide all water treatment functions in connection with each individual fish tank. However, it is expensive to equip each tank with for example aeration, solid matter separation and biological purification units. In addition, the size of a centralized bioreactor can be based on the average feed load on farm level, whereas the size of a tank-specific bioreactor should be sized according to the maximum feed load in the tank. Bioreactors adapt to changing feed loads slowly, and after disinfection for example, maturation and proper functioning of a tank-specific biological purification unit would take several weeks or even months. Therefore, this alternative has been less popular.

Additionally, in the conventional fish farms, there is a single fresh water pipeline and a single effluent water pipeline for each tank. The water must be pumped from the tanks through the entire water treatment process irrespective of what are the prevailing water quality factors that limit the production.

Conventional recirculation aquaculture farms utilizing centralized water treatment also suffer from fish health issues. As pathogens cannot be isolated from the common water recirculation, once a single tank has been infected, the pathogens will inevitably spread across all tanks in the farm. For the same reason, use of antibiotics in a single tank will affect all tanks in the farm and interrupt sale of fish from the entire farm. Measurable antibiotics concentrations will spread across all tanks and the drug withdrawal times must be applied to all tanks.

A significant issue is the off-flavour problem caused by compounds such as geosmins and 2-methylisoborneol. Separate purging tanks are expensive to build and the purging process is labour intensive. In addition, the fish lose weight (up to 15%) during purging/fasting period prior the harvest.

One of the problems is the high energy consumption of the current high-head RAS technologies (high pumping height difference).

Also fish health and welfare issues have been compromised in recent RAS farms, as the priority has been in reducing investment costs. It is cheaper to build centralized water treatment units, but on the other hand it makes all-in-all-out production strategy impossible and also medications very challenging, often practically impossible.

Embodiments of the present invention are aimed at solving at least some of the above discussed problems.

### SUMMARY OF THE INVENTION

The invention is defined by the features of the independent claims. Some specific embodiments are defined in the dependent claims.

According to a first aspect of the present invention, there is provided an aquaculture system, such as a fish or shrimp farming system, based on recirculation aquaculture, the system comprising: at least two farming tanks; at least one tank-specific water treatment unit that is connected to one of the tanks and configured to treat water of said tank; at least one shared water treatment unit that is connected to all of the tanks and configured to treat water that is recirculating in the system; and a means for recirculating water in the system.

Various embodiments of the first aspect may comprise at least one feature from the following bulleted list:
The farming tanks are land-based tanks or floating tanks.
At least one of the tanks comprises a new water inlet that is connected to a new water line.
Each tank comprises a water inlet that is connected to the recirculation.
Each tank comprises a water outlet that is connected to a common effluent water line.
Said common effluent water line is connected to an inlet of said at least one shared water treatment unit.
Said water inlets and said water outlet of the tanks are configured to be disconnectable from the system and reconnectable to the system.
Said at least one tank-specific water treatment unit comprises a tank-specific unit for aeration of the water in the tank and/or exchange of gases in the water of the tank.
Said aeration or exchange of gases comprises supplementation of air or oxygen into the water of the tank, such as oxygenation.
Said aeration or exchange of gases comprises removal of carbon dioxide from the water of the tank.
Said at least one tank-specific water treatment unit comprises a tank-specific unit for removal of solid matter from the water of the tank.
The solid matter comprises settleable solid matter or coarse solid matter, for example faeces and/or waste feed.
Said tank-specific unit for removal of solid matter comprises a gravity-based settler, such as a radial flow settler or a swirl separator.
Said at least one tank-specific water treatment unit comprises a tank-specific unit for removal of fine suspended solids from the water of the tank by means of flotation.
Said at least one shared water treatment unit comprises a shared unit for removal of solid matter from the recirculating water.
Said solid matter comprises fine solid matter.
Said shared unit for removal of solid matter comprises a filter, such as a drum filter, a drum screen, a belt filter, or a flotation unit.
Said at least one shared water treatment unit comprises a shared unit for biological treatment of the recirculating water.
Said shared unit for biological treatment comprises a moving bed bioreactor, a fixed bed bioreactor, a fluidized bed bioreactor or a trickling tower bioreactor.
Said means for recirculating water comprises an airlift pump, a centrifugal pump or an axial-flow pump.

According to a second aspect of the present invention, there is provided a method of farming aquatic organisms, such as fish or shrimp, by using the system according to the first aspect.

According to a third aspect of the present invention, there is provided a method of farming aquatic organisms, such as fish or shrimp, typically in a system based on recirculation aquaculture, comprising: upon reaching the slaughter time of the fish or the shrimp in a farming tank, purging the fish or the shrimp by: providing disinfected water or a disinfectant to the tank, during a purging period, allowing off-flavour substances to become purged from the fish, during at least a first part of the purging period, feeding the fish, after said purging period, harvesting the fish from the tank for slaughter.

Various embodiments of the second aspect or the third aspect may comprise at least one feature from the following bulleted list:
Each of the tanks is operated according to flow-thru, partial recirculation or recirculation principle, independently of each other.
At intervals at least one of the tanks is operated according to flow-thru principle, wherein the water inlet and the water outlet of said tank have been disconnected from the recirculation.
At intervals at least one of the tanks is operated according to partial recirculation principle, wherein either the water inlet or the water outlet of said tank has been disconnected from the recirculation.
At intervals at least one of the tanks, preferably all tanks, are operated according to recirculation principle.
The method comprises operating at least one of the tanks according to flow-thru, partial recirculation or recirculation principle for a period of time for the purpose of acclimating the fish or shrimp in said tank for flow-thru, partial recirculation or recirculation conditions, respectively.
After said period of time, transferring the acclimated fish or shrimp from the tank to said conditions outside the system.
The method comprises disconnecting the water outlet of a tank from the system, directing effluent water from the tank to outside the system, disinfecting the tank, introducing new fish or shrimp to the tank, and after a period of time, after the health status of the fish or shrimp has been confirmed, reconnecting the water outlet of the tank to the system.
The method comprises disconnecting the water outlet of a tank from the system, directing effluent water from the tank to outside the system, treating the fish or shrimp in the tank with a drug, such as antibiotics, and after ending said treatment and after a determined withdrawal period has lapsed, reconnecting the water outlet of the tank to the system.
The method comprises: upon reaching the slaughter time of the fish or shrimp in a tank, purging the fish or shrimp respectively by: providing disinfected water to the tank, during a purging period, allowing off-flavour substances to become purged from the fish or shrimp, after said purging period, harvesting the fish or shrimp from the tank for slaughter.
The method comprises, before providing disinfected water to the tank: disconnecting the water inlet of the tank from the recirculation.
Said purging period consists of a feeding period and a subsequent fasting period.
The method comprises feeding new disinfected water to at least one of the tanks.
Said disinfected water has been obtained by using a disinfectant which may be hydrogen peroxide, peracetic acid or ozone, or by UV radiation sterilization, or by a combination thereof.
The method comprises disinfecting, such as in situ, the water in at least one of the tanks by feeding hydrogen peroxide into the tank for a period of time.
The method comprises disinfecting, such as in situ, the water in at least one of the tanks by feeding peracetic acid into the tank for a period of time.
The method comprises disinfecting, such as in situ, the water in at least one of the tanks by feeding ozone into the tank for a period of time.
The method comprises disinfecting, such as in situ, the water in at least one of the tanks by an Advanced Oxidation Process (AOP) for a period of time.
Said disinfecting is carried out for the purpose of reducing accumulation of or removing off-flavour substances or for the purpose of removing fish or shrimp pathogens.
For substantially most of the time said biological water treatment unit is connected to the system and receives effluent water from at least one of the tanks.
Said providing of disinfected water or a disinfectant is carried out continuously or in a pulsed manner by feeding one or more pulses of disinfected water or a disinfectant to the tank, preferably during at least a part of the purging period.
Said feeding is stopped 0.5 to 5 days, such as 2 to 4 days before the end of the purging period.
During the purging period: the tank being purged is not connected to any biological water treatment unit in the system, and preferably the tank being purged is connected to a gas exchange unit specific for said tank.
The system according to the first aspect is used.

According to a fourth aspect of the present invention, there is provided use of both tank-specific water treatment units and such water treatment units that are common to all tanks in an aquaculture system, such as a fish or shrimp farming system, said system comprising several farming tanks and being configured for recirculation aquaculture.

### Advantages of the Invention

Some embodiments of the present invention may provide improved water quality. Tank-specific settleable/coarse solids removal system supports better water quality than centralized solid removal systems because particles are removed close to where they are formed before they break down to smaller particles that are more difficult to remove and which release their nutrients into the water.

The present invention may provide improved energy efficiency in gas exchange. Tank-specific gas exchange is more energy efficient than current centralized gas exchange systems; the higher the concentration differences are, the more effective the process is.

Some embodiments of the present invention may provide reduced high-head water pumping needs and improved energy efficiency. Water oxygen levels and carbon dioxide concentration are the main two factors that are limiting production in aquaculture. Pumping rates and energy consumption of pumping for other water treatment processes can be significantly reduced, when gas exchange is tank specific.

Some embodiments of the present invention may provide reduced pipe and equipment costs. As high exchange rates are not necessary due to gas exchange, water flow to centralized (common) water treatment units can be reduced. Thus smaller pipe dimensions and smaller device sizes can be used, which reduces investment costs.

Some embodiments of the present invention may provide improved fish growth and bioreactor or biofilter performance. As high pumping rates are not necessary due to gas exchange, a higher ammonia concentration in the fish tank is possible. High ionized ammonia can work as a growth promoter for the fish. A high concentration of ammonia also directly improves the nitrification capacity of the biofilter. Thus, the fish grow faster, and a smaller and cheaper biofilter can be used.

Some embodiments of the present invention may provide reduced tank investment costs. As any of the grow-out tanks can be switched from RAS mode to PRAS mode or flow-thru mode, separate off-flavouring tanks are not needed.

Some embodiments of the present invention may provide reduced fish stress and mortality, better growth and reduced labour costs in fish logistics. As off-flavouring can be done in the grow-out tank, less fish transfers are necessary. Fish transfers typically stress the fish and cause mortality. Less fish transfers therefore means better fish welfare and better fish farming economy.

Some embodiments of the present invention may provide improved production capacity and profitability. As tank-specific solid removal systems and gas exchange systems are still functioning when the tank is removed from recirculation loop (typically at least from a biofilter), and oxidizing agents like H₂O₂ can be used to remove tank-level off-flavour compounds, feeding can be continued during the off-flavouring period. As the fish keep growing during the off-flavouring period, the process can yield 10 to 20% more biomass for sale. In addition, approximately 5 to 10% less feed is needed to produce the same amount of fish, as the fish are not losing weight before harvest and sale. Feed cost is roughly 50% of all production costs, and this has thus a big impact on production cost.

In some embodiments, significantly improved energy efficiency brings recirculation aquaculture closer to carbon neutrality. The new innovative fish farm type utilizes centralized and decentralized water treatment, which makes intelligent demand-driven water treatment possible.

The present invention may enable better protection of the system from biological risks of a tank.

The present invention may enable better protection of a tank from chemical risks of the system.

The present invention may enable total or partial isolation of any of the tanks from the centralized water treatment at any time.

### BRIEF DESCRIPTION OF THE DRAWINGS

FIG. 1 illustrates a system in accordance with at least some embodiments of the present invention; and

FIGS. 2 to 6 illustrate results from experiments carried out in a system in accordance with at least some embodiments of the present invention.

### EMBODIMENTS

### Definitions

In the present context, the term “recirculation aquaculture” comprises production of aquatic animals, preferably fish, in a system which includes a water recirculation system having water treatment units including a biological water treatment unit, such as a bioreactor or a biofiltration unit.

In the present context, the term “recirculation principle or conditions” comprises recirculation of water between a fish tank and water treatment units including a biological water treatment unit, such as a bioreactor or a biofiltration unit, and possibly some other water treatment units.

In the present context, the term “partial recirculation principle or conditions” comprises recirculation or re-use of water in a fish tank or between a fish tank and external water treatment units, typically without any biological water treatment unit.

In the present context, the term “flow-thru principle or conditions” comprises flow of water through fish tanks. There is no recirculation or re-use of water in the fish tank or between the fish tanks and external water treatment units. Effluent water may be treated by so called end of pipe water treatment units.

In the present context, the term “land-based tank” comprises a tank that has its foundations on land.

In the present context, the term “floating tank” comprises a tank or a closed container that is floating in a sea or in fresh water such as in a lake.

In the present context, the term “fresh water line” typically refers to an influent new water line or a line inputting new water.

In the present context, “gas exchange” is typically synonymous with “aeration” and comprises both removal of carbon dioxide and addition of oxygen. Gas exchange or aeration units may be supplemented also with other gases than air.

“Oxygenation” refers to feeding of pure oxygen.

In the present context, the term “purging” is typically synonymous with the term “depuration”.

In the present context, the term “farming” is typically synonymous with the terms “cultivating” and “rearing”.

In the present invention it has been surprisingly observed that the combination of centralized and distributed water treatment methods in a fish farm may provide unexpected benefits and enable operation of the farm according to various principles, such as full recirculation, partial recirculation and flow-thru.

According to some embodiments, water treatment steps such as aeration, gas exchange and settleable solids removal may be carried out by distributed units or tank-specific units, each in connection with a particular individual fish tank.

A tank-specific unit may be physically located inside the tank or alternatively outside the tank but adjacent to it or in immediate proximity of it.

According to some embodiments, water treatment steps such as flotation-based or filtration-based solids removal and biological water treatment may be carried out by common units, in a centralized manned for the entire fish farm.

The invention may be applied either in a recirculation aquaculture farm as well as in a modular plant for cultivating aquatic species, such as the facility described in WO2021240061A1.

In an embodiment, gas exchange is carried out by tank-specific units. Gas exchange is most effective at points where concentration differences of gases are the largest.

In an embodiment, aeration is carried out by tank-specific units. It is advantageous to carry out aeration in this way because oxygen demand varies between tanks.

In an embodiment, oxygenation is carried out by tank-specific units.

In an embodiment, removal of coarse solids is carried out by tank-specific units. It is advantageous to remove large settleable solid particles from the recirculation before they break down and form smaller, soluble particles. In this way the need for further water treatment steps, particularly the need for solids removal, becomes decreased.

In an embodiment, removal of fine solids is carried out by a shared filtration based unit. Such a filtration unit is typically expensive, and therefore it is advantageous to include only a single unit per farm.

In an embodiment, biological water treatment is carried out by a shared unit, such as a shared bioreactor. A biological water treatment unit is typically expensive, and therefore it is advantageous to include only a single unit per farm. Additionally, a biological water treatment unit typically requires a continuous and even load, which can be better ensured by feeding effluent waters from several tanks to the same biological water treatment unit. In any individual tank, the amount of fish and the amount of feed used, and consequently also the biological load coming from any individual tank to the bioreactor, may vary significantly, whereas on the farm level the biological load stays more constant.

In an embodiment, water treatment units may be operated and fed with water on the basis of water quality measurements. Water may be directed to the water treatment units and functions based on the actual need at any given time. The amount of pipelines needed for achieving such intelligent water treatment may be decreased when some of the water treatment functions are tank-specific and placed in connection with individual tanks.

In some embodiments, the fish farming system comprises less and/or smaller-diameter pipelines than the conventional farms for recirculation aquaculture: Even though each tank must be equipped with its own fresh water line, the effluent water line may be common to all tanks. In addition, large hydraulic loads of conventional farms for recirculation aquaculture are not needed as the gas exchange is tank-specific. The effluent water line may be realized as a trough, which may also be utilized as a channel for transferring fish.

In a recirculation aquaculture system, the fish tanks must be provided with enough oxygen, and secretions that are harmful to the fish must be removed: carbon dioxide, ammonium and faeces (solids).

Typically, it is the carbon dioxide concentration that first rises to a level that is harmful to the fish. Therefore, in conventional RAS farms, removal of carbon dioxide determines the water pumping need, both the amount of water pumped and the pumping height. The water pumping need determines the energy consumption of the farm.

Gas exchange, such as addition of oxygen and removal of carbon dioxide, is most effective in the fish tank, because then the gas exchange takes place at a point where the carbon dioxide concentration is the highest and the oxygen concentration is the lowest. A large concentration difference speeds up the gas exchange, thereby decreasing the need to pump water in the whole farm, and the resource effectiveness of the entire water treatment process is increased. At the same time the operation of the bioreactor is improved as it is possible to keep the ammonium concentrations in the incoming effluent waters at higher levels.

Tank-specific gas exchange may reduce the energy consumption of the farm by more than 50% as the need to pump water is lessened (lower water pumping height).

Solids removal is more effective if it is carried out close to the location where the solids are being generated. For example, by placing a radial-flow settler or a swirl separator in connection with a tank, to treat effluent water from said tank, any settleable faeces and waste feed can be removed before they are disintegrated to smaller non-settleable particles which are more difficult to remove.

Fast removal of solids may decrease the amount of soluble nutrients and carbon in the water, as well as bacteria counts in the water, which correlate well with particle counts in the water and with available carbon and nutrient concentrations. In addition, biological oxygen demand caused by decomposition of organic matter is reduced, and thus oxygen/energy consumption of the whole farm is lower.

Fast removal of solids may decrease the amount of soluble nutrients and carbon in the effluent water.

If a substantial part of most of the solid matter is removed by settling near the place of generation, it may be possible to have a smaller-capacity fine solids removal unit, such as a smaller-capacity drum filter, as the centralised solids removal unit. The centralised solids removal unit may also be better adapted for removal of fine solid matter as the coarse solid matter has already been removed by tank-specific units.

The present invention may provide cost benefits during construction of a fish farm and also during running the farm.

The present invention may introduce flexibility by enabling the individual fish tanks to be operated according to full recirculation, partial recirculation or flow-thru principle.

The present system may be advantageous for research use. In research use, the invention may bring many advantages due to its flexibility. One single system offers three options for research: flow-thru, partial recirculation, and full recirculation water treatment principles.

The present system may enable a low pumping height (low head), for example less than 1 meter, for example less than 0.5 meters, such as less than 0.3 meters, or for example as low as about 0.3 meters. The low head immediately translates to a low energy consumption and a small carbon footprint of the farm.

In the present invention, the need to pump water may decrease significantly, because the trickling filters needed in carbon dioxide removal may be dispensed with.

In the present invention, as the gas exchange may be carried out by feeding air to water instead of feeding water to air, and as the various water treatment processes may not be dependent on the same water flow, also the effectiveness of aeration and accordingly energy consumption may be better controlled and adjusted.

The present invention provides an improved recirculation aquaculture system which has similarities with the so called ‘all in, all out’ farming principle, which is a biosafe production strategy as recognized in all animal production.

The fish may be introduced to a tank that is being operated according to partial recirculating principle so that the effluent water from the tank is directed out from the system. The tank is preferably disinfected. Once the fish have grown a bit and their health status has been confirmed, the tank may be connected to the centralized water treatment loop including a biological water treatment unit. When the slaughter time of the fish approaches, the tank may again be disconnected from the biological water treatment unit. This is possible since aeration and solids removal take place in connection with the tank. The inlet fresh water (i.e. the inlet new water) is introduced to the tank after disinfecting the water by for example hydrogen peroxide. The tank is operated according to partial recirculation principle. The effluent water from the tank may be used as inlet water in such part of the system that is connected to the biological water treatment.

The system according to the present invention may be particularly advantageous for the production of food fish or edible fish, typically for human consumption, as it provides improved possibilities for controlling and reducing off-flavours. In some embodiments, the fish are one or more of the following: Atlantic salmon, tilapia, rainbow trout, European whitefish, brown trout, arctic charr, sturgeon, pike perch and eel.

The system according to the present invention may be advantageous for the production of shrimp.

Before slaughter and selling of the fish, they need to be purged to remove off-flavour substances from the flesh of the fish.

In the conventional purging methods, the fish are placed in separate purging tanks and not fed at all during the purging. The purging period may endure up to two weeks. Because of the fasting, the fish may lose 5 to 15% of their weight during the conventional purging period.

Some embodiments of the present invention may provide benefits in connection with purging of fish. It may be possible to continue feeding the fish during the first part of the purging period. The purging involves disconnecting the tank to be purged from the recirculation and feeding fresh water into the tank. Such continued feeding of the fish keeps the metabolism of the fish more active in comparison to fasting fish. In this way removal of accumulated off-flavour substances may be more effective. Also profitability of the fish production is increased as the fish do not lose so much weight during purging. Fasting may be necessary only during the last days of the purging period, for example for 2 to 3 days in order to empty the intestinal tracts of the fish. The entire length of the purging period may be 8 to 12 days.

In some embodiments, weight loss of the fish may be reduced or avoided during the purging.

In an embodiment, transfer of fish from the rearing tanks to separate purging tanks is not needed, which reduced the stress experienced by the fish and the mortality of the fish and the human resources needed at the farm.

The present invention may be advantageous in fry and fingerling production.

The present invention may be advantageous in situations where acclimation of the fish is necessary.

The present invention may facilitate combining traditional (non-recirculation) aquaculture and recirculation aquaculture.

In the present system the fish may be acclimated to either flow-thru conditions or partial recirculation conditions or full recirculation conditions. After such acclimating, the fish may be safely transferred to a corresponding production environment, irrespective of the time of year or season.

An individual fish tank may be operated according to partial recirculation at any time when desired, for example for the purpose of administering a drug to the fish in said tank. In this way the microbes of the bioreactor do not become disturbed. Additionally, any drug withdrawal time will not apply to the entire farm but only to the tank to which the drug is being administered.

The present system may be operated according to the partial recirculation principle but without the bioreactor. However, the bioreactor may still be utilized for treating effluents that are directed out from the system, in order to keep the bioreactor functional and capable of being reconnected to the recirculation at any time. The bioreactor converts the nitrogen that is in ammonium form to nitrate form. Thus, nitrogen removal from effluents will be possible for example by means of a denitrification bioreactor, such as a denitrification wood chip bioreactor.

In an embodiment, the biological water treatment unit is a moving bed bioreactor and the means for recirculating water is an air-lift pump. The advantages are that gas exchange is improved, need for vertical pumping water is reduced, and the energy consumption of the farm is reduced.

In an embodiment, the low water pumping head makes it possible to use an airlift pump, which is energy efficient. An airlift pump also improves gas exchange.

Next, we describe a fish farming system according to some embodiments in more detail.

In a preferred embodiment, the fish farming system is based on recirculation aquaculture and comprises at least two fish farming tanks. The system comprises at least one tank-specific water treatment unit that is connected to one of the tanks and configured to treat water of said tank, and at least one shared water treatment unit that is connected to all of the tanks and configured to treat water that is recirculating in the system. The system also includes a means for recirculating water in the system.

The fish farming tanks may be land-based tanks or alternatively floating tanks. Land-based tanks are preferred.

At least one of the tanks comprises a fresh water inlet that is connected to a fresh water line (i.e. new water line). The system is fed with fresh water (new water) via said fresh water line (new water line). The fresh water (new water) enters the recirculation.

Additionally, each tank typically comprises a water inlet that is connected to the recirculation loop.

In an embodiment, each tank comprises a water outlet that is connected to a common effluent water line. Said common or shared effluent water line is connected to an inlet of said at least one shared water treatment unit.

In an embodiment, at least part of, preferably all of said water inlets and said water outlets of the tanks are configured to be disconnectable from the system and reconnectable to the system. The advantage is that various operating modes of the system are enabled, such as partial recirculation for one or more of the tanks.

Said at least one tank-specific water treatment unit may comprise a tank-specific unit for aeration of the water in the tank.

Said at least one tank-specific water treatment unit may comprise a tank-specific unit for exchange of gases in the water of the tank.

Said exchange of gases or aeration typically comprises feeding of air or oxygen into the water of the tank and removal of carbon dioxide from the water of the tank.

Said at least one tank-specific water treatment unit may comprise a tank-specific unit for removal of solid matter from the water of the tank.

For example, the solid matter may comprise settleable solid matter or coarse solid matter, such as fish faeces and/or waste fish feed.

Said tank-specific unit for removal of solid matter may comprise a gravity-based settler, such as a vertical clarifier or a radial flow settler or a swirl separator. Preferably the gravity-based settler is a radial flow settler.

In an embodiment, said at least one tank-specific water treatment unit comprises a tank-specific unit for removal of fine suspended solids from the water of the tank, for example by means of flotation.

Said at least one shared water treatment unit may comprise a shared unit for removal of solid matter from the recirculating water.

Typically said solid matter comprises fine solid matter, such as solid matter that is not settleable.

In an embodiment, said shared unit for removal of solid matter comprises a filter, a drum filter, a drum screen, a belt filter or a flotation unit.

Said at least one shared water treatment unit may comprise a shared unit for biological treatment of the recirculating water.

Said shared unit for biological treatment may comprise a bioreactor, such as a moving bed bioreactor, a fixed bed bioreactor, a fluidized bed bioreactor or a trickling tower bioreactor. Preferably the bioreactor is a moving bed bioreactor.

Said means for recirculating water may comprise an airlift pump, a centrifugal pump or an axial-flow pump, preferably an airlift pump. A conventional water pump may be used.

In the following we describe methods of farming fish according to some embodiments.

In some embodiments, the method of farming fish is carried out by the system described above.

Each of the tanks may be operated according to full recirculation, partial recirculation or flow-thru principle, independently of each other.

The operating principle of any individual tank may be changed when desired for a desired time period.

For example, at intervals or for a period of time, at least one of the tanks may be operated according to flow-thru principle, wherein the tank has been disconnected from the recirculation, which typically means that the water inlet(s) and the water outlet(s) of said tank have been disconnected from the recirculation loop.

As another example, at intervals or for a period of time, at least one of the tanks is operated according to partial recirculation principle, which typically means that either the water inlet or the water outlet of said tank has been disconnected from the recirculation loop.

As still another example, at intervals of for a period of time, at least one of the tanks, preferably all tanks, are operated according to recirculation principle.

The above described examples may be combined so that any combination of tanks operated according to full recirculation, partial recirculation or flow-thru principle may exist in the system, and the operating principles of individual tanks may be changed over time as desired.

In an embodiment, fish in one of the tanks need to be acclimated to particular conditions. Then, the tank may be operated according to flow-thru, partial recirculation or full recirculation principle for a period of time for the purpose of acclimating the fish in said tank for flow-thru, partial recirculation or recirculation conditions, respectively. After such an acclimation period, the acclimated fish may be transferred from the tank to corresponding conditions outside the system. The present invention may enable such acclimation to take place without fish welfare problems and mortalities associated to direct transfers to different environmental conditions.

In an embodiment, new fish are to be introduced to one of the tanks. In such a situation, the method may comprise disconnecting the water outlet of said tank from the system, directing effluent water from the tank to outside the system, disinfecting the tank, and then introducing new fish to the disinfected tank. After the introduction, the health status of the fish is monitored. Once it has been confirmed that the new fish are healthy and thus not susceptible of spreading pathogens to the fish in the other tanks, the water outlet of the tank where the new fish are located is reconnected to the system.

In an embodiment, medication, such as administration of antibiotics, is carried out for the fish in a particular tank. In such a situation, the method may comprise disconnecting the water outlet of the tank from the system, directing effluent water from the tank to outside the system, and then treating the fish in the tank with a drug, such as antibiotics. After ending said treatment, a withdrawal period follows, during which the drug withdraws from the treated fish. After the withdrawal period, the water outlet of the tank can be reconnected to the recirculation without any risk of introducing the drug to the other tanks.

In an embodiment, the fish in a tank are to be harvested and slaughtered for sale. In such a situation, the fish need to purged or depurated from off-flavour substances. The method typically comprises disconnecting the water inlet of the tank from the recirculation, providing off-flavour-free clean water, possibly disinfected water, to the tank, and during a determined purging period, allowing off-flavour substances to become purged from the fish. After said purging period, the fish can be harvested from the tank for slaughter.

Off-flavour problems typically arise in RAS systems but may also appear in PRAS systems.

In some embodiments, said purging period consists of a feeding period and a subsequent fasting period. During the fasting period the fish are not fed. The purging period may be at least 5 days, for example 6 to 10 days. The fasting period may be less than 5 days, for example 2 to 4 days.

In some embodiments, disinfection of a tank may be carried out. Such disinfection may be realized by introducing fresh disinfected water to the tank. Said disinfected water may be obtained by using a disinfectant, which may be hydrogen peroxide, peracetic acid and/or ozone, or by UV radiation sterilization, or by a combination thereof.

Alternatively or in addition, the disinfection may be realized in situ by disinfecting the water in the tank by feeding a disinfectant into the tank to achieve a determined disinfectant concentration, typically for a period of time.

Said disinfecting may be carried out for the purpose of reducing accumulation of off-flavour substances in the fish or for removing off-flavour substances from the fish. The disinfecting may also be carried out for the purpose of removing fish pathogens from the tank.

In some embodiments, a disinfectant and/or an oxidant is fed to the fish tank to be purged or being purged. Said disinfectant and/or an oxidant may be selected from the following group: hydrogen peroxide, peracetic acid, ozone and any combinations thereof. Advanced oxidation processes (AOP) may be used.

By AOP it is referred to use of at least two processes selected among disinfecting processes and oxidizing processes. For example, the combination of ozone and UV light may be applied, or the combination of ozone and hydrogen peroxide, or the combination of hydrogen peroxide and UV light. Such combinations may provide synergistic effects.

For example, the disinfectant may be hydrogen peroxide, and it may be fed to the tank so that the concentration of hydrogen peroxide in the tank is maintained at a level of at least 1 mg/L, for example at least 2 mg/L, for example at least 3 mg/L, such as 1 to 10 mg/L, preferably 3 to 5 mg/L.

The feeding of a disinfectant or an oxidant may be carried out as continuous feeding or as pulsed feeding.

The disinfectant or the oxidant may be fed directly into the tank or alternatively it may be fed upstream from the tank, to the new water line. In the latter case it becomes possible to disinfect also the new water.

It is preferred that for substantially most of the time the biological water treatment unit is connected to the system and receives effluent water from at least one of the tanks. In this way the biological load may be kept at a sufficient and stable level for the unit to operate properly.

The invention also relates to using both tank-specific water treatment units and such water treatment units that are common to all tanks in a fish farming system. Typically said fish farming system comprises several fish tanks and is configured for at least recirculation aquaculture.

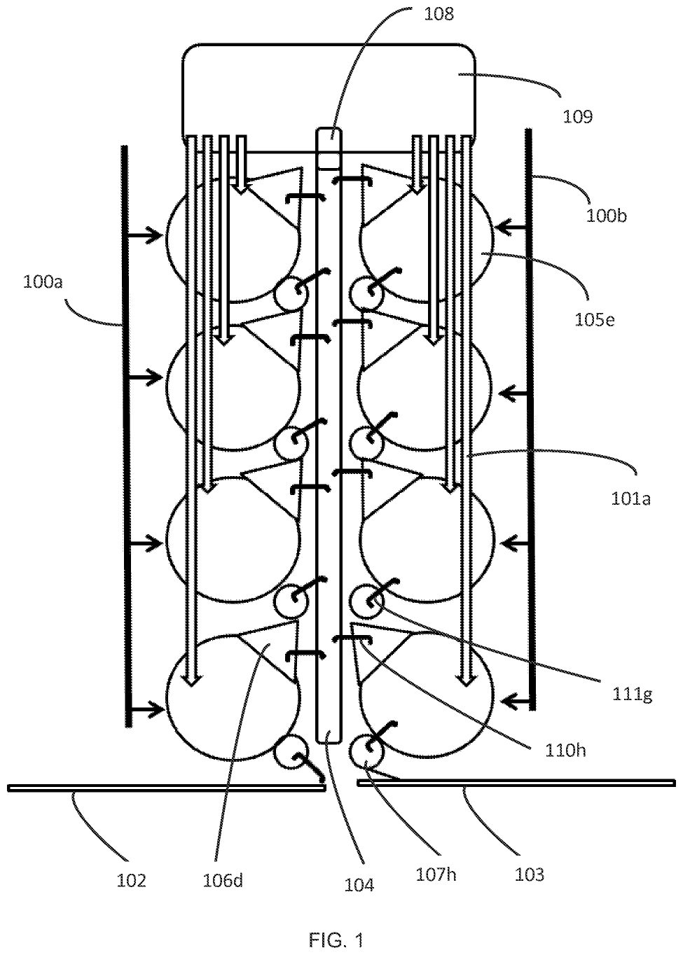

FIG. 1 illustrates a system in accordance with at least some embodiments of the present invention. The system includes a moving bed bioreactor (MBBR) and an air-lift pump. Particularly, the system comprises:
100a, 100b new water line
101a water recirculation line operated by an airlift pump
102 effluent line
103 sludge line
104 common effluent pipe
105e fish tank
106d tank-specific aeration unit
107h radial flow settler
108 drum filter
109 moving bed bioreactor
110h over-flow from the tank-specific aeration unit
111g over-flow from the radial flow settler

The system comprises eight fish tanks, such as the tank 105e. There are four tanks on both sides of the common conduit 104 towards the shared units. Each tank has its own aeration unit (triangles), such as 106d, and coarse matter (settleable solids) removal unit, such as 107h. The fine matter removal unit 108 is shared, and the biological purification unit (MBBR) 109 is also shared. The arrows such as 101a depict water recirculation pipes and the arrows 100a and 100b depict fresh water inlet pipes.

### EXAMPLES

In the following we describe data from a Hybrid Aquaculture System (HAS) experiment. The HAS is a system according to an embodiment of the present invention.

The HAS had tank-specific aeration devices and radial-flow settlers for gas exchange and solid removal respectively. Drum filter and moving bed bioreactors were common for all six tanks. Fish tank size was 500 litres. The experiment had three phases. Phase 1 (restricted feeding 33 days) for newly arrived fish for health status clarification and biofilter acclimation: All tanks were used as partial recirculation systems and tank effluent water was directed to biofilter. Phase 2 (ad libitum feeding 40 days), which was the main production phase: Tanks were connected to the biofiltration and fine solids removal loop. Phase 3 (restricted feeding or no feeding) was a depuration process for off-flavour removal. During the depuration all tanks were turned to partial recirculation mode by disconnecting them from the biofiltration loop, and hydrogen peroxide dosing was started. Two feeding regimes were compared during the depuration process: feeding (restricted feeding) and fasting (no feeding). Water use during phase 1 was 10000 l/kg feed, during phase 2 (RAS) water use was 650 l/kg feed, and during phase 3 the hydraulic retention time was 3.5 hours, which equals 8800 l/kg feed in feeding group (groups A1, A2, A4 and A5). In hydrogen peroxide dosing the concentration of 5 mg/l was used.

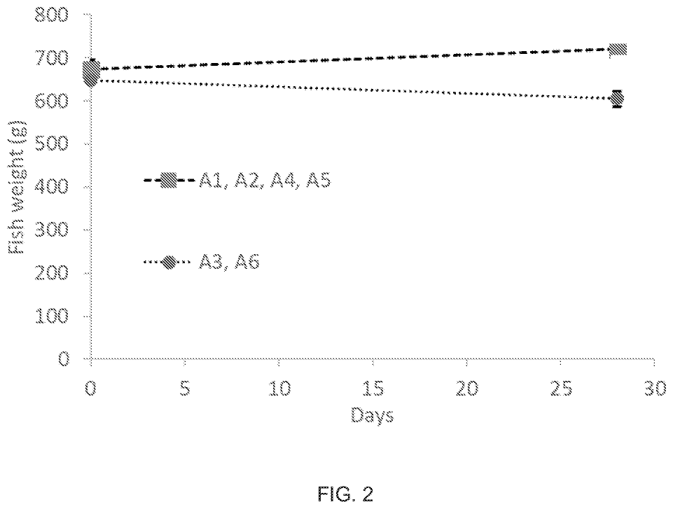

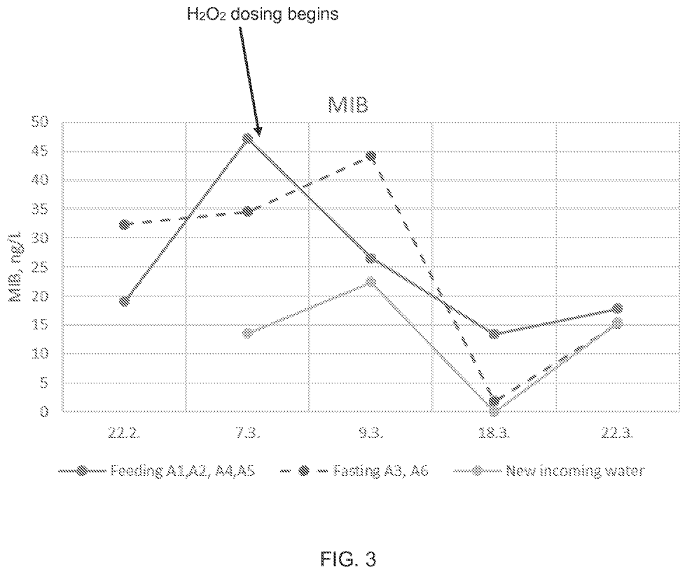

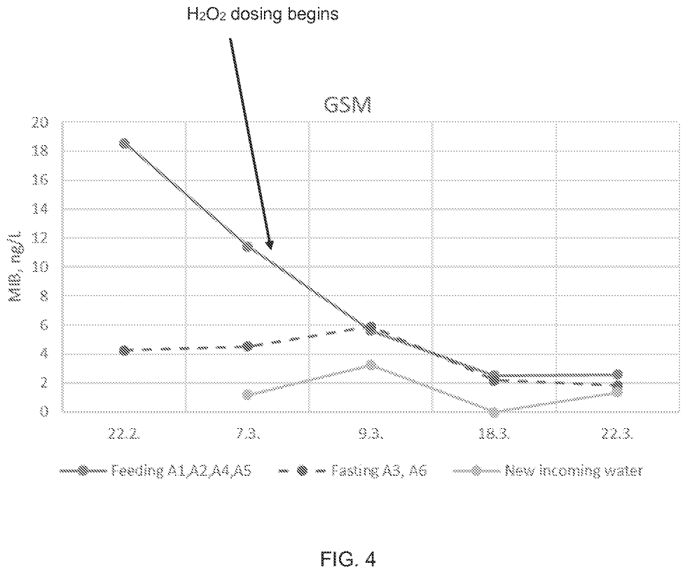

Results: The fish biomass increased 6.93% in the fish groups (A1, A2, A4 and A5) that were fed during 28 days depuration period, whereas biomass decreased 6.49% in the fish groups (A3 and A6) that were not fed (see FIG. 2). Concentrations of off-flavour chemicals geosmin (GSM) and 2-methylisoborneol (MIB) in the water decreased at the same rate in both treatments and reached the concentration of the water source (new incoming water) by the end of the experiment (see FIGS. 3 and 4). Also GSM and MIB concentrations in fish flesh came down below sensory thresholds in both groups (sensory threshold of 0.9 μg/kg for GSM and 0.7 μg/kg for MIB in rainbow trout has been suggested by R. Robertson et al., 2005).

It can be concluded that the Hybrid Aquaculture System/process can be used to separate the fish tanks at any time of the production cycle. In the end of the production cycle tank specific gas exchange and settleable solid separation enable feeding during the depuration process. According to the experiment results, the Hybrid Aquaculture System can produce 13.4% more sellable biomass than conventional RAS production model. Also feed efficiency is improved as the fish are not losing weight before harvest. As feed conversion ratio of 1.0 is common in trout production, weight decrease of 6.49% in the fasted group means also 6.49% more feed consumption in RAS-production than in HAS-production for the same amount of fish production. Feed is the major production cost in aquaculture, roughly 50% of the total production costs.

The results are illustrated in FIGS. 2 to 6;

FIG. 2: Weight development of the rainbow trout during depuration process. Tanks A1, A2, A4 and A5 were fed during the depuration period. Tanks A3 and A6 had a depuration process that is currently used by the recirculation aquaculture industry and the fish were fasting during depuration.

FIG. 3: Off-flavour chemical 2-methylisoborneol (MIB) concentrations in tank water and in the water source (new incoming water) in Hybrid Aquaculture System experiment. Tanks A1, A2, A4 and A5 were fed during the depuration process. Tanks A3 and A6 had a depuration process that is currently used by the recirculation aquaculture industry and the fish were fasting during depuration.

FIG. 4: Off-flavour chemical geosmin (GSM) concentrations in tank water and in the water source (new incoming water) in Hybrid Aquaculture System experiment. Tanks A1, A2, A4 and A5 were fed during the depuration process. Tanks A3 and A6 had a depuration process that is currently used by the recirculation aquaculture industry and the fish were fasting during depuration.

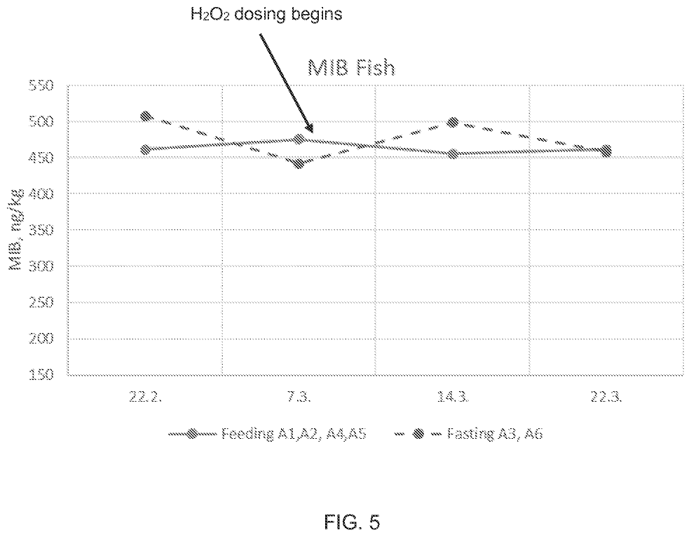

FIG. 5: Off-flavour chemical 2-methylisoborneol (MIB) concentrations in fish flesh in Hybrid Aquaculture System experiment. Tanks A1, A2, A4 and A5 were fed during the depuration process. Tanks A3 and A6 had a depuration process that is currently used by the recirculation aquaculture industry and the fish were fasting during depuration.

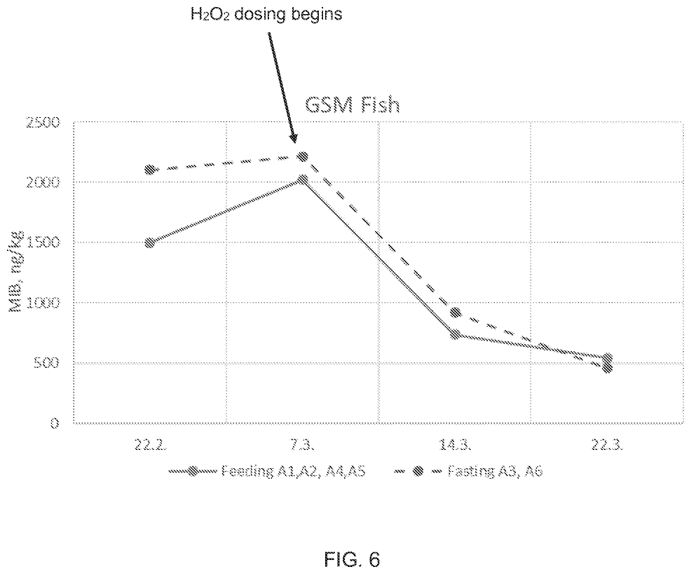

FIG. 6: Off-flavour chemical geosmin (GSM) concentrations in fish flesh in Hybrid Aquaculture System experiment. Tanks A1, A2, A4 and A5 were fed during the depuration process. Tanks A3 and A6 had a depuration process that is currently used by the recirculation aquaculture industry and the fish were fasting during depuration.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present invention is industrially applicable at least in aquaculture of fish and shrimp.

### ACRONYMS LIST

RAS Recirculation Aquaculture System
PRAS Partial Recirculation Aquaculture System or Partial Re-use Aquaculture System
MBBR Moving Bed Bioreactor
GSM geosmin
MIB 2-methylisoborneol
AOP Advanced Oxidation Process

### REFERENCE SIGNS LIST

100a, 100b new water line
101a water recirculation line operated by an airlift pump
102 effluent line
103 sludge line
104 common effluent pipe
105e fish tank
106d tank-specific aeration unit
107h radial flow settler
108 drum filter
109 moving bed bioreactor
110h over-flow from the tank-specific aeration unit
111g over-flow from the radial flow settler

### CITATION LIST

### Patent Literature

WO 2021240061 A1

### Non Patent Literature

R. Robertson et al.: “Depuration rates and the sensory threshold concentration of geosmin responsible for earthy-musty taint in rainbow trout, Onchorhynchus mykiss”, March 2005, Aquaculture 245(1-4):89-99.

1. An aquaculture system, the system comprising:
at least two farming tanks;
at least one tank-specific water treatment unit that is connected to one of the fa tanks and configured to treat water of said tank;
at least one shared water treatment unit that is connected to all of the n tanks and configured to treat water that is recirculating in the system; and
a means for recirculating water in the system.

2. The system according to claim 1, wherein the farming tanks are land-based tanks or floating tanks.

3. The system according to claim 1, wherein at least one of the at least tow farming tanks comprises a new water inlet that is connected to a new water line, and
wherein each tank comprises a water inlet that is connected to the recirculation.

4. The system according to claim 1, wherein each tank comprises a water outlet that is connected to a common effluent water line, and wherein said common effluent water line is connected to an inlet of said at least one shared water treatment unit.

5. The system according to claim 1, wherein said water inlets and said water outlet of the tanks are configured to be disconnectable from the system and reconnectable to the system.

6. The system according to claim 1, wherein said at least one tank-specific water treatment unit comprises a tank-specific unit for aeration of the water in the tank and/or exchange of gases in the water of the tank.

7. The system according to claim 6, wherein said aeration and/or exchange of gases comprises supplementation of air or oxygen into the water of the tank.

8. The system according to claim 6, wherein said aeration or exchange of gases comprises removal of carbon dioxide from the water of the tank.

9. The system according to claim 1, wherein said at least one tank-specific water treatment unit comprises a tank-specific unit for removal of solid matter from the water of the tank.

10. The system according to claim 9, wherein the solid matter comprises settleable solid matter or coarse solid matter.

11. The system according to claim 9, wherein said tank-specific unit for removal of solid matter comprises a gravity-based settler.

12. The system according to claim 1, wherein said at least one tank-specific water treatment unit comprises i) a tank-specific unit for exchange of gases comprising supplementation of air and/or oxygen into the water of the tank, wherein said exchange of gases comprises removal of carbon dioxide from the water of the tank; and ii) a tank-specific unit for removal of settleable solid matter from the water of the tank.

13. The system according to claim 1, wherein said at least one shared water treatment unit comprises a shared unit for removal of solid matter from the recirculating water.

14. The system according to claim 13, wherein said solid matter comprises fine solid matter.

15. The system according to claim 13, wherein said shared unit for removal of solid matter comprises a filter, a drum filter, a drum screen, a belt filter, or a flotation unit.

16. The system according to claim 1, wherein said at least one shared water treatment unit comprises a shared unit for biological treatment of the recirculating water.

17. The system according to claim 16, wherein said shared unit for biological treatment comprises a moving bed bioreactor, a fixed bed bioreactor, a fluidized bed bioreactor or a trickling tower bioreactor.

18. The system according to claim 1, wherein said means for recirculating water comprises an airlift pump, a centrifugal pump or an axial-flow pump.

19. A method of farming aquatic organisms by using the system according to claim 1.

20. The method according to claim 19, wherein each of the tanks is operated according to flow-thru, partial recirculation or recirculation principle, independently of each other.

21. The method according to claim 19, wherein at intervals at least one of the tanks is operated according to flow-thru principle, wherein the water inlet and the water outlet of said tank have been disconnected from the recirculation.

22. The method according to claim 19, wherein at intervals at least one of the tanks is operated according to partial recirculation principle, wherein either the water inlet or the water outlet of said tank has been disconnected from the recirculation.

23. The method according to claim 19, wherein at intervals at least one of the tanks are operated according to recirculation principle.

24. The method according to claim 19, further comprising:
operating at least one of the tanks according to flow-thru, partial recirculation or recirculation principle for a period of time for the purpose of acclimating the fish or shrimp in said tank for flow-thru, partial recirculation or recirculation conditions, respectively, and
after said period of time, transferring the acclimated fish or shrimp from the tank to said conditions outside the system.

25. The method according to claim 19, further comprising:
disconnecting the water outlet of a tank from the system,
directing effluent water from the tank to outside the system,
disinfecting the tank,
introducing new fish or shrimp to the tank, and
after a period of time, after the health status of the fish or shrimp has been confirmed, reconnecting the water outlet of the tank to the system.

26. The method according to claim 19, further comprising:
disconnecting the water outlet of a tank from the system,
directing effluent water from the tank to outside the system,
treating the fish or shrimp in the tank with a drug, such as antibiotics, and
after ending said treatment and after a determined withdrawal period has lapsed, reconnecting the water outlet of the tank to the system.

27. The method according to claim 9, further comprising:
upon reaching the slaughter time of the fish or shrimp in a tank, purging the fish or shrimp respectively by:
providing disinfected water to the tank,
during a purging period, allowing off-flavour substances to become purged from the fish or shrimp,
after said purging period, harvesting the fish or shrimp from the tank for slaughter.

28. The method according to claim 27, further comprising, before providing disinfected water to the tank: disconnecting the water inlet of the tank from the recirculation.

29. The method according to claim 27, wherein said purging period consists of a feeding period and a subsequent fasting period.

30. The method according to claim 19, further comprising feeding disinfected water to at least one of the tanks, wherein said disinfected water has been obtained by using a disinfectant selected from hydrogen peroxide, peracetic acid or ozone, or by UV radiation sterilization, or by a combination thereof.

31. The method according to claim 30, comprising disinfecting the water in at least one of the tanks by feeding hydrogen peroxide into the tank for a period of time.

32. The method according to claim 30, comprising disinfecting the water in at least one of the tanks by feeding peracetic acid into the tank for a period of time.

33. The method according to claim 30, comprising disinfecting the water in at least one of the tanks by feeding ozone into the tank for a period of time.

34. The method according to claim 30, comprising disinfecting the water in at least one of the tanks by Advanced Oxidation Process (AOP) for a period of time.

35. The method according to claim 30, wherein said disinfecting is carried out for the purpose of reducing accumulation of or removing off-flavour substances or for the purpose of removing fish or shrimp pathogens.

36. The method according claim 19, wherein for substantially most of the time said biological water treatment unit is connected to the system and receives effluent water from at least one of the tanks.

37. (canceled)

38. A method of farming aquatic organisms, the method comprising:
upon reaching the slaughter time of the fish or the shrimp in a farming tank, purging the fish or the shrimp by:
providing disinfected water or a disinfectant to the tank,
during a purging period, allowing off-flavour substances to become purged from the fish,
during at least a first part of the purging period, feeding the fish, and
after said purging period, harvesting the fish from the tank for slaughter.

39. The method according to claim 38, wherein said providing of disinfected water or a disinfectant is carried out continuously or in a pulsed manner by feeding one or more pulses of disinfected water or a disinfectant to the tank.

40. The method according to claim 38, wherein said feeding is stopped 0.5 to 5 days before the end of the purging period.

41. The method according to claim 38, wherein during the purging period:
the tank being purged is not connected to any biological water treatment unit in the system, and
the tank being purged is connected to a gas exchange unit specific for said tank.

42. (canceled)
